(19) United States
(12) Patent Application Publication
(10) Pub. No.: US 2026/0179342 A1
(43) Pub. Date: Jun. 25, 2026

(54) IMAGE PROCESSING APPARATUS, IMAGE PROCESSING METHOD, AND STORAGE MEDIUM

(71) Applicant: CANON KABUSHIKI KAISHA, Tokyo (JP)

(72) Inventor: Waki MIDORIKAWA, Kanagawa (JP)

(21) Appl. No.: 19/427,134

(22) Filed: Dec. 19, 2025

(30) Foreign Application Priority Data
Dec. 25, 2024 (JP) 2024-229365

(51) Int. Cl. G06T 19/20; G06T 7/50; G06T 7/70

(52) U.S. Cl. CPC G06T 19/20; G06T 7/50; G06T 7/70

(57) ABSTRACT

To simultaneously view the orientations of a target object at a plurality of time points in a period including a time code corresponding to a model figure, or in a period around the time code. An image processing apparatus according to the present disclosure obtains capturing information containing data on a captured image and a camera parameter corresponding to the captured image, the captured image having been obtained by capturing a model figure corresponding to a shape of an object at a given time code, and generates virtual content including a representation of the object corresponding to the model figure based on the capturing information.

### BACKGROUND

### Field of the Technology

The present disclosure relates to an augmented reality (AR) display technology that uses figures generated based on a video image.

### Description of the Related Art

There exists a technology for modeling a 3D model figure by inputting 3D shape data corresponding to an object, which has been generated through volumetric capturing or three-dimensional (hereinafter referred to as “3D”) computer graphics, for example, into a 3D printer. By using a plurality of pieces of 3D shape data corresponding to different time codes of a scene including a sequence of motions of an identical object, it is possible to obtain 3D model figures (hereinafter referred to as “figures”) corresponding to the respective time codes. A plurality of figures modeled based on a sequence of motions of an identical object may be used to analyze or view the motions of the object in a scene including the sequence of motions.

There also exists a technology for superimposing a volumetric video image or 3D digital content on a video image of a real space, and displaying the resulting image, using a display device capable of representing AR (augmented reality). Japanese Patent Laid-Open No. 2022-131778 (hereinafter referred to as “Patent Literature 1”) discloses a technology for capturing a figure to display a moving image corresponding to a scene in a period including a time code corresponding to the figure. Specifically, according to the technology disclosed in Patent Literature 1, an image corresponding to the appearance of some object seen from a given virtual viewpoint (hereinafter referred to as a “virtual viewpoint image”) is displayed as a moving image corresponding to the scene. According to the technology disclosed in Patent Literature 1 (hereinafter referred to as a “conventional technology”), a user is able to, by capturing a figure, view motions of a target object in a scene related to the figure as the moving image.

### SUMMARY

According to the conventional technology, a scene in a period including a time code corresponding to a figure is displayed as a moving image. Therefore, the conventional technology has a problem in that it is difficult to view the orientations of a target object at a plurality of time points in the period while comparing them. The present disclosure is directed to provide a technology that allows for simultaneous viewing of the orientations of a target object at a plurality of time points in a period including a time code corresponding to a figure, or in a period around the time code.

An image processing apparatus according to the present disclosure, includes: one or more hardware processors; and one or more memories storing one or more programs configured to be executed by the one or more hardware processors, the one or more programs including instructions for: obtaining capturing information containing data on a captured image and a camera parameter corresponding to the captured image, the captured image having been obtained by capturing a model figure corresponding to a shape of an object at a given time code, and generating virtual content including a representation of the object corresponding to the model figure based on the capturing information.

Features of the present disclosure will become apparent from the following description of embodiments with reference to the attached drawings. The following description of embodiments are described by way of example.

### BRIEF DESCRIPTION OF THE DRAWINGS

FIG. 1 is a block diagram illustrating an example of a system configuration according to Embodiment 1;

FIGS. 2A to 2D are views each illustrating an example of a captured image according to Embodiment 1;

FIGS. 3A to 3C are charts for describing examples of data held in a storage apparatus according to Embodiment 1;

FIG. 4 is a block diagram illustrating an example of the logical configuration of an image processing apparatus according to Embodiment 1;

FIGS. 5A to 5D are views each illustrating an example of a layout region according to Embodiment 1;

FIGS. 6A to 6D are views each illustrating an example of the arrangement of virtual viewpoint images according to Embodiment 1;

FIG. 7 is a block diagram illustrating an example of the hardware configuration of the image processing apparatus according to Embodiment 1;

FIG. 8 is a flowchart illustrating an example of a process flow of the image processing apparatus according to Embodiment 1;

FIGS. 9A to 9D are views illustrating examples of a captured image and the arrangement of virtual viewpoint images according to Embodiment 2; and

FIGS. 10A and 10B are views illustrating another example of a captured image and the arrangement of virtual viewpoint images according to Embodiment 2.

### DESCRIPTION OF THE EMBODIMENTS

Hereinafter, with reference to the attached drawings, the present disclosure is explained in detail in accordance with preferred embodiments. Configurations shown in the following embodiments are merely exemplary and the present disclosure is not limited to the configurations shown schematically. Incidentally, an identical reference numeral is assigned to an identical constituent and an explanation thereof is made.

### Embodiment 1

This embodiment will describe an aspect of a case where an image generated based on a captured image, which has been obtained by capturing a plurality of figures arranged by a user, for example, is viewed using a device capable of displaying AR.

### System Configuration of Image Processing System

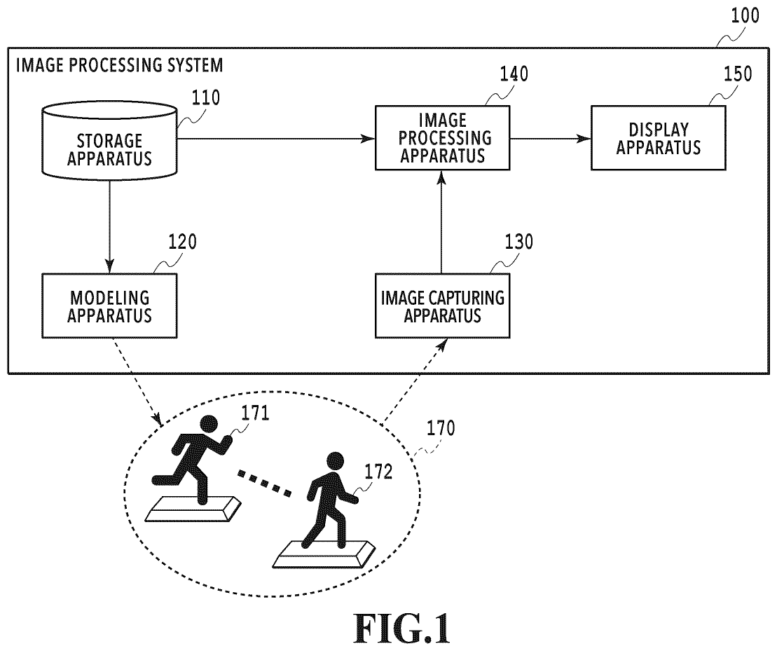

FIG. 1 is a block diagram illustrating an example of the system configuration of an image processing system 100 according to Embodiment 1. The image processing system 100 includes a storage apparatus 110, a modeling apparatus 120, an image capturing apparatus 130, an image processing apparatus 140, and a display apparatus 150.

The storage apparatus 110 includes a hard disk drive, for example, and holds various data used to perform an image generation process with the image processing apparatus 140 and a figure modeling process with the modeling apparatus 120. The details of the various data held in the storage apparatus 110 will be described later. The modeling apparatus 120 includes a 3D printer, for example, and receives, as an input, at least part of the various data held in the storage apparatus 110 to model a figure group 170 including FIGS. 171 and 172. The details of the FIGS. 171 and 172 modeled by the modeling apparatus 120 will be described later.

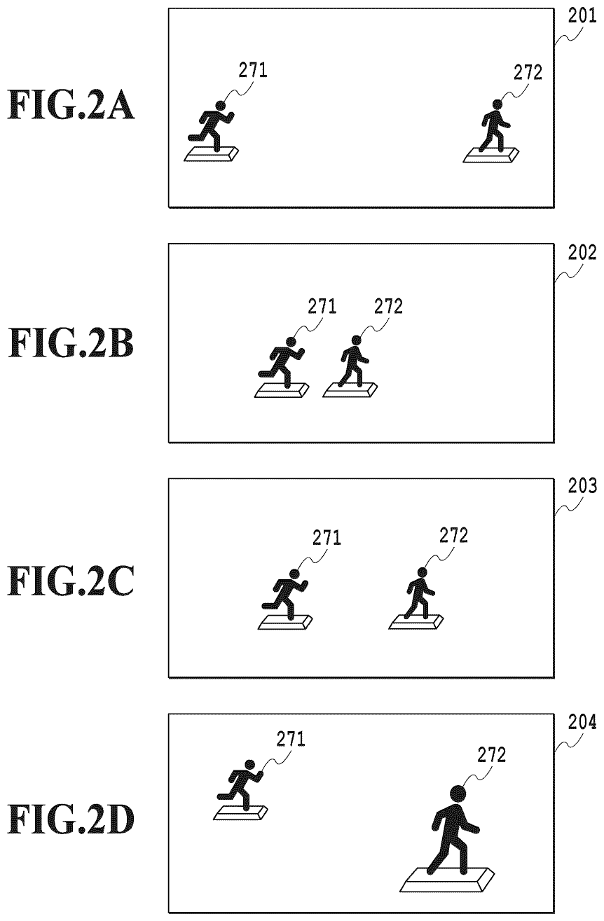

The image capturing apparatus 130 includes a digital still camera, a digital video camera, or a portable terminal, such as a smartphone with an image capturing function, and captures the FIGS. 171 and 172 arranged by a user. The image capturing apparatus 130 outputs to the image processing apparatus 140 capturing information including data on a captured image obtained by capturing the FIGS. 171 and 172, camera parameters corresponding to the captured image, and information on an image sensor of the image capturing apparatus 130. FIGS. 2A to 2D are views respectively illustrating examples of captured images 201 to 204 obtained by capturing with the image capturing apparatus 130 according to Embodiment 1. Representations 271 and 272 included in each of the captured images 201 to 204 illustrated in FIGS. 2A to 2D are representations of the FIGS. 171 and 172, respectively.

The image processing apparatus 140 includes a computer, for example, and generates virtual content based on the capturing information output from the image capturing apparatus 130 and at least part of the various data held in the storage apparatus 110. Herein, the virtual content refers to an image including one or more representations of an object corresponding to the FIGS. 171 and 172. Hereinafter, the virtual content will be described as including one or more virtual viewpoint images generated based on information indicating the 3D shape of an object. The details of the virtual content and a generation method therefor will be described later. The image processing apparatus 140 outputs to the display apparatus 150 data on or a signal of the virtual content and data on or a signal of the captured image contained in the capturing information. The display apparatus 150 includes a liquid crystal display, for example, and displays the virtual content and the captured image by superimposing them one on top of the other based on the data on or the signal of the virtual content and the data on or the signal of the captured image contained in the capturing information that have been output from the image processing apparatus 140.

In this embodiment, the image capturing apparatus 130, the image processing apparatus 140, and the display apparatus 150 are described as being mounted in different housings. However, the configuration of the technology of the present disclosure is not limited thereto. Specifically, at least two or more of the image capturing apparatus 130, the image processing apparatus 140, and the display apparatus 150 may be mounted in the same housing, and operate as a single apparatus. For example, the image capturing apparatus 130 and the display apparatus 150 may be mounted in the same housing, or all of the image capturing apparatus 130, the image processing apparatus 140, and the display apparatus 150 may be mounted in the same housing.

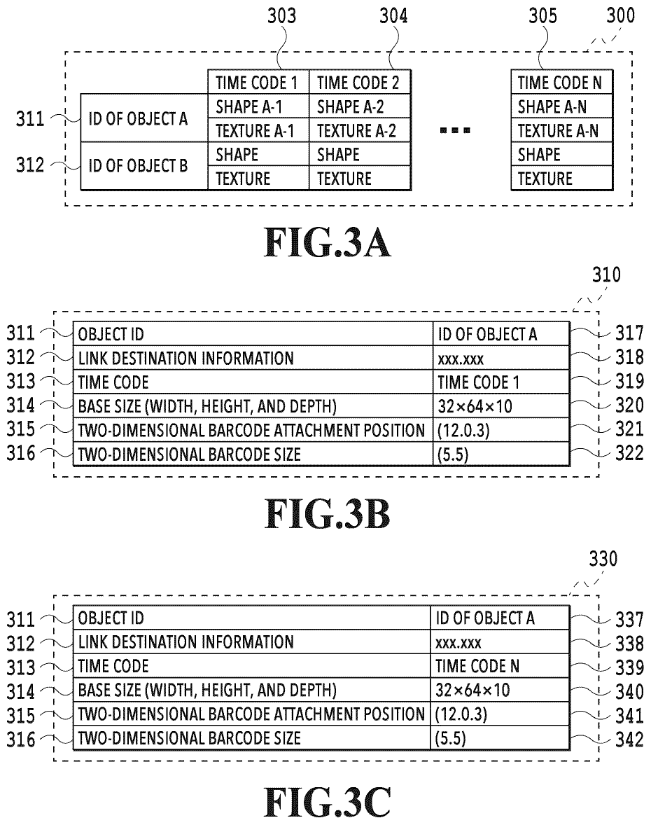

FIGS. 3A to 3C are charts for describing examples of the data held in the storage apparatus 110 according to Embodiment 1. FIG. 3A illustrates an example of object information 300 related to two objects A and B, generated through volumetric capturing or 3D computer graphics, for example. The following description is based on the assumption that each object is identifiable, like an animal or a natural person, and has an orientation that changes over time, and thus, in response to a change in the orientation of the object over time, the 3D shape corresponding to the object as well as a texture corresponding to the 3D shape will also change over time.

As illustrated in FIG. 3A, each 3D shape data is held in association with an ID (identifier) 311 or 312 that can uniquely identify the corresponding object A or B, and with the corresponding texture data. The following description is based on the assumption that in a case where a captured image obtained through volumetric capturing includes representations of a plurality of objects, a target object to be modeled as a figure or a target object to be rendered in the virtual content generated by the image processing apparatus 140 is uniquely identified. For example, an object may be uniquely identified based on the position (i.e., coordinates) of the representation of the object in the captured image. In a case where there is only one target object to be modeled as a figure or only one target object to be rendered in the virtual content, the object ID may be omitted. In the following description, a dataset including the ID, 3D shape data, and texture data of an object, which are associated with one another, is referred to as 3D model information. Since the orientations of the objects A and B change over time, the 3D model information at each time point is held in association with each of time codes 303 to 305.

In this embodiment, description is made on the assumption that the 3D model information is associated with a corresponding time code. However, the 3D model information may be associated with not only a time code, but also any information that can uniquely identify a time point corresponding to the 3D model information. For example, the 3D model information may be associated with the frame number or the like of the captured image obtained through volumetric capturing and used to generate the 3D model information.

FIGS. 3B and 3C illustrate examples of modeling information 310 and 330 input to the modeling apparatus 120. For example, as the modeling information 310 is input to the modeling apparatus 120, the modeling apparatus 120 models the FIG. 171, and as the modeling information 330 is input to the modeling apparatus 120, the modeling apparatus 120 models the FIG. 172. Specifically, each of the modeling information 310 and 330 contains an object ID field 311, a link destination field 312, and a time code field 313, for example. In addition, each of the modeling information 310 and 330 also contains a base size field 314, a two-dimensional barcode attachment position field 315, and a two-dimensional barcode size field 316.

Each of item values 317 and 337 in the object ID field 311 stores the ID of an object corresponding to a figure to be modeled. Each of item values 318 and 338 in the link destination field 312 stores information, such as a URL (Uniform Resource Locator), indicating the location where the object information 300 is stored. Each of item values 319 and 339 in the time code field 313 stores a time code corresponding to the FIG. 171 or 172 to be modeled.

Each of item values 320 and 340 in the base size field 314 stores information indicating the size including the width, height, and depth of a base that supports the FIG. 171 or 172 to be modeled. Each of item values 321 and 341 in the two-dimensional barcode attachment position field 315 stores information indicating the position of the FIG. 171 or 172 to be modeled or a two-dimensional barcode to be formed on the surface of the base supporting the FIG. 171 or 172. Each of item values 322 and 342 in the two-dimensional barcode size field 316 stores information indicating the sizes in the longitudinal direction and horizontal dimension of the two-dimensional barcode to be formed.

In modeling the FIG. 171, the modeling apparatus 120 forms a two-dimensional barcode, which includes as information the item values 317 to 322 corresponding to the respective fields contained in the modeling information 310, on the FIG. 171 or on the surface of the base supporting the FIG. 171, for example. That is, the FIG. 171 is a figure representing the 3D shape of the object A at a time point corresponding to a time code 1. Specifically, the modeling apparatus 120 forms a two-dimensional barcode with a size designated by the item value 322 in the two-dimensional barcode size field 316 and at a position designated by the item value 321 in the two-dimensional barcode attachment position field 315.

Similarly, in modeling the FIG. 172, the modeling apparatus 120 forms a two-dimensional barcode, which includes as information the item values 337 to 342 corresponding to the respective fields contained in the modeling information 330, on the FIG. 172 or on the surface of the base supporting the FIG. 172, for example. That is, the FIG. 172 is a figure representing the 3D shape of the object A at a time point corresponding to a time code N. Specifically, the modeling apparatus 120 forms a two-dimensional barcode with a size designated by the item value 342 in the two-dimensional barcode size field 316 and at a position designated by the item value 341 in the two-dimensional barcode attachment position field 315. The following description is based on the assumption that the time code 1 is a time code corresponding to a time point earlier than the time point of the time code N.

Examples of the two-dimensional barcode include QR codes (registered trademark). In this embodiment, description is made on the assumption that a two-dimensional barcode is formed on the surface of a base supporting a figure. However, not only a two-dimensional barcode, but also anything, which may contain as information each item value contained in the modeling information, may be formed. Specifically, a device, such as a barcode or an NFC (Near Field Communication) or RFID (radio frequency identification) tag, which is formed or implemented in a case where a figure is modeled, and which may allow each item value contained in the modeling information to be obtained in a case where the figure is captured, may be used, instead of a two-dimensional barcode.

### Logical Configuration of Image Processing Apparatus

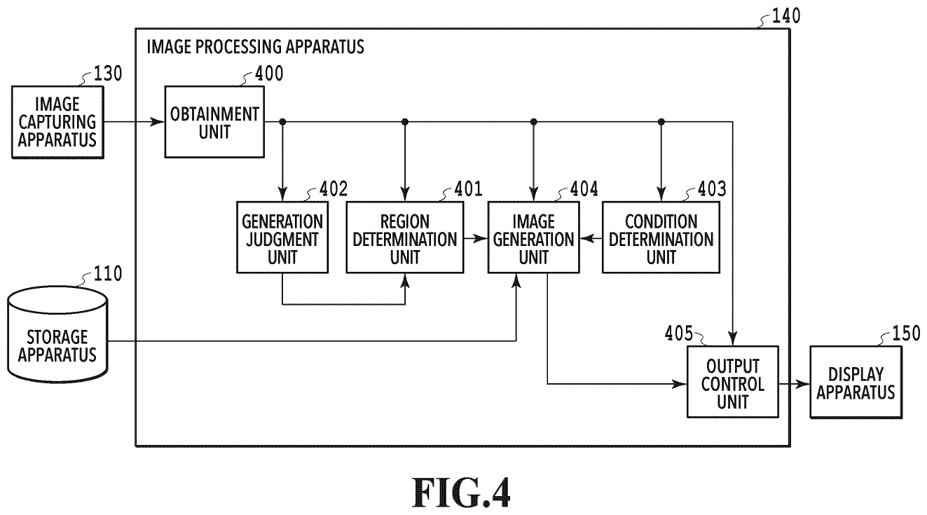

FIG. 4 is a block diagram illustrating an example of the logical configuration of the image processing apparatus 140 according to Embodiment 1. The image processing apparatus 140 includes an obtainment unit 400, a region determination unit 401, a generation judgment unit 402, a condition determination unit 403, an image generation unit 404, and an output control unit 405. The obtainment unit 400 obtains capturing information output from the image capturing apparatus 130. In addition, the obtainment unit 400 obtains the item value in each field contained in the modeling information based on the captured image contained in the capturing information. Specifically, the obtainment unit 400 first identifies a representation of a two-dimensional barcode contained in the captured image, formed on the surface of the base supporting the FIG. 171 or 172, for example. Then, the obtainment unit 400 decodes the two-dimensional barcode identified as a representation to obtain the item value in each field of the modeling information 310 or 330 contained as information in the two-dimensional barcode. The generation judgment unit 402 judges if virtual content can be generated based on the item value in each field of the modeling information 310 and 330 obtained by the obtainment unit 400.

The region determination unit 401 determines the region (hereinafter referred to as a “layout region”) where virtual viewpoint images generated based on the 3D model information contained in the object information 300 are to be arranged in the virtual content. Specifically, the region determination unit 401 first estimates the arrangement and orientation of each of the FIGS. 171 and 172 using the captured image and camera parameters contained in the capturing information obtained by the obtainment unit 400 and using each item value of the modeling information 310 and 330. Next, the region determination unit 401 determines the region (i.e., layout region) where virtual viewpoint images are to be arranged in the virtual content, based on the estimated arrangement and orientation of each of the FIGS. 171 and 172. Specifically, the region determination unit 401 estimates the orientation and arrangement of each of the image capturing apparatus 130 and the FIGS. 171 and 172 based on each item value of the modeling information; the camera parameters contained in the capturing information; and the shape, size, and position of a region of the representation of the two-dimensional barcode in the captured image.

For example, to estimate the orientation and arrangement of each of the FIGS. 171 and 172, the region determination unit 401 uses information contained as the item values of the modeling information, such as the size of the base supporting the FIG. 171 or 172, the attachment position of the two-dimensional barcode, and the size of the two-dimensional barcode. Specifically, the region determination unit 401 estimates the orientation and arrangement of each of the FIGS. 171 and 172 based on the correspondence between the size of the base supporting each figure as well as the position and size of the two-dimensional barcode and the shape and position of the representation of the figure in the captured image.

The information used to estimate the orientation and arrangement of each of the image capturing apparatus 130 and the FIGS. 171 and 172 is not limited to the foregoing information. For example, in a case where the image capturing apparatus 130 includes a depth sensor, a gyroscope sensor, an acceleration sensor, or the like, the image capturing apparatus 130 outputs the capturing information containing sensor data on such a sensor. In such a case, the region determination unit 401 estimates the orientation and arrangement of each of the image capturing apparatus 130 and the FIGS. 171 and 172 using the sensor data contained in the capturing information, in addition to the foregoing information. In addition, the region determination unit 401 may determine the layout region based on the positions of regions including the respective representations of the FIGS. 171 and 172 in the captured image. In such a case, the region determination unit 401 determines as the layout region a region sandwiched between the region including the representation of the FIG. 171 in the captured image and the region including the representation of the FIG. 172 in the captured image, for example.

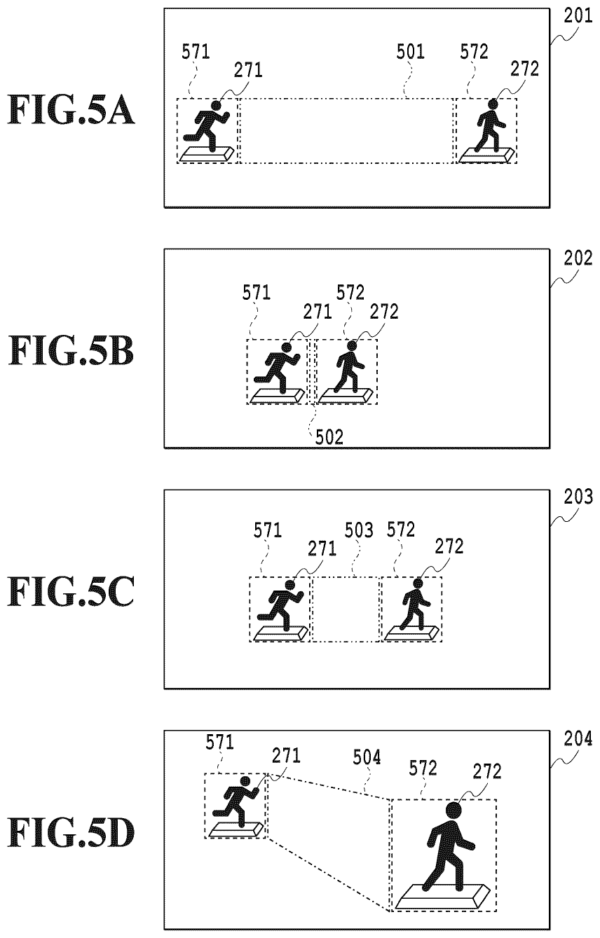

FIGS. 5A to 5D are views respectively illustrating examples of layout regions 501 to 504 determined by the region determination unit 401 according to Embodiment 1. Specifically, FIGS. 5A to 5D respectively illustrate examples of the layout regions 501 to 504 corresponding to the captured images 201 to 204 illustrated in FIGS. 2A to 2D. In FIGS. 5A to 5D, a region 571 is a region including the representation 271 of the FIG. 171 included in each of the captured images 201 to 204, and a region 572 is a region including the representation 272 of the FIG. 172 included in each of the captured images 201 to 204.

The condition determination unit 403 determines the conditions for generating a virtual viewpoint image to be arranged in the layout region. Specifically, the condition determination unit 403 determines a time code corresponding to the 3D model information used to generate a virtual viewpoint image, and the position of a virtual viewpoint as well as the viewing direction at the virtual viewpoint used to generate the virtual viewpoint image using the 3D model information. In addition, the condition determination unit 403 also determines the position where the generated virtual viewpoint image is to be arranged in the layout region. The details of the method for determining the conditions for generating a virtual viewpoint image to be arranged in the layout region will be described later.

The image generation unit 404 generates virtual content. Specifically, the image generation unit 404 first accesses the object information 300 using the item value in the link destination field 312 contained in the modeling information 310 or 330. Next, the image generation unit 404 obtains 3D model information corresponding to the item value in the object ID field 311 and the time code determined by the condition determination unit 403 from among pieces of 3D model information contained in the object information 300. Next, the image generation unit 404 uses the obtained object information 300 to generate a virtual viewpoint image corresponding to the appearance of the object seen from the virtual viewpoint determined by the condition determination unit 403. Next, the image generation unit 404 generates virtual content by arranging the generated virtual viewpoint image at the position determined by the condition determination unit 403 in the layout region determined by the region determination unit 401.

The output control unit 405 outputs to the display apparatus 150 data on or a signal of the virtual content generated by the image generation unit 404 and data on or a signal of the captured image contained in the capturing information obtained by the obtainment unit 400. The virtual content and the captured image output from the output control unit 405 are superimposed one on top of the other by the display apparatus 150 for display.

### Examples of Arrangement of Virtual Viewpoint Images in Virtual Content

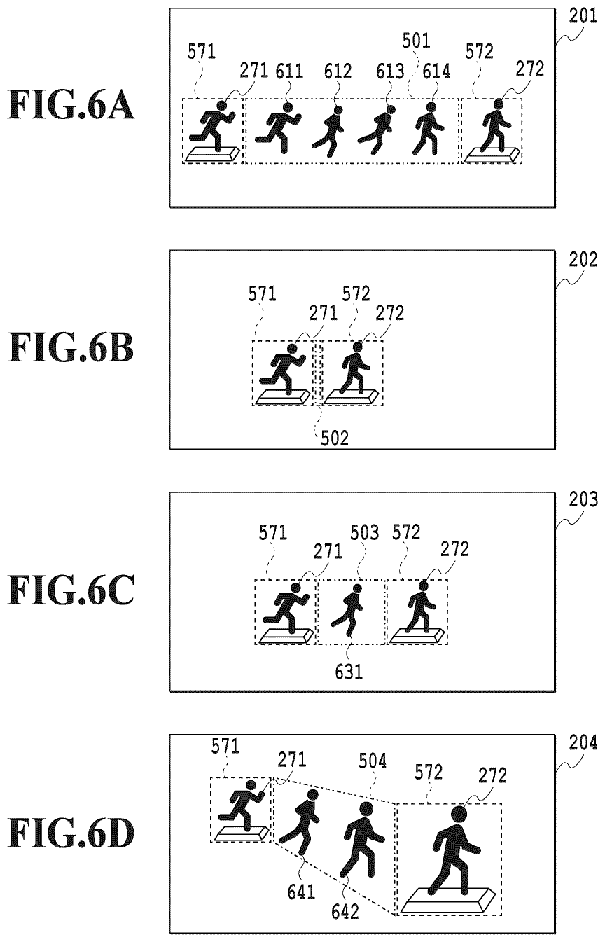

FIGS. 6A to 6D are views each illustrating an example of the arrangement of virtual viewpoint images in the virtual content generated by the image generation unit 404 according to Embodiment 1. Specifically, FIGS. 6A to 6D illustrate examples of virtual viewpoint images 611 to 614, 631, and 641 and 642 arranged in the layout regions 501 to 504 illustrated in FIGS. 5A to 5D. Note that FIGS. 6A to 6D each represent the state of an AR display where the virtual content generated by the image generation unit 404 and the captured image contained in the capturing information obtained by the obtainment unit 400 are superimposed one on top of the other. As illustrated in FIGS. 6A, 6C, and 6D, in a case where the virtual content is superimposed on the captured image by the display apparatus 150, for example, the virtual content is displayed between the respective representations 271 and 272 of the two the FIGS. 171 and 172. Therefore, each of the layout regions 501 to 504 may be calculated as a region sandwiched between the representation 271 of the FIG. 171 and the representation 272 of the FIG. 172 in a plane corresponding to the display surface of the captured image, based on the coordinates of the region 571 including the representation 271 of the FIG. 171 and the coordinates of the region 572 including the representation 272 of the FIG. 172.

The sizes of the representation 271 of the FIG. 171 and the representation 272 of the FIG. 172 included in the captured image 201 illustrated in FIG. 2A are about the same. In such a case, the image generation unit 404 generates virtual content where the virtual viewpoint images 611 to 614, which have about the same size as each of the region 571 including the representation 271 of the FIG. 171 and the region 572 including the representation 272 of the FIG. 172 illustrated in FIG. 5A, are arranged in the layout region 501. Herein, the judgment of whether the size of the representation 271 of the FIG. 171 and the size of the representation 272 of the FIG. 172 are about the same can be made by checking whether the difference in size between the region 571 and the region 572 is within ±10%, for example. The way of judging the sizes of the representation 271 of the FIG. 171 and the representation 272 of the FIG. 172 is not limited thereto. For example, the judgment may be made based on the sizes of the representation of the base supporting the FIG. 171 and the representation of the base supporting the FIG. 172, or the sizes of the representations of the two-dimensional barcodes, each included in the captured image.

In the captured image 201, the region 571 including the representation 271 of the FIG. 171 and the region 572 including the representation 272 of the FIG. 172 are present at positions away from each other. Therefore, the plurality of virtual viewpoint images 611 to 614, each having about the same size as the regions 571 and 572, are arranged at equal intervals, for example, in the layout region 501 set between the regions 571 and 572. Specifically, the condition determination unit 403 determines the number of virtual viewpoint images that can be arranged in the layout region 501, and the position at which each virtual viewpoint image is to be arranged in the layout region 501, based on the width of each of the regions 571 and 572 and the width of the layout region 501. Herein, the width of each of the regions 571 and 572 is the mean value of the width of the region 571 and the width of the region 572, for example.

In addition, each of the virtual viewpoint images 611 to 614 arranged in the layout region 501 is an image generated using 3D model information for a time code included in a period between the time codes of the FIGS. 171 and 172 included as representations in the captured image 201. The time codes of the FIGS. 171 and 172 are obtained by decoding the two-dimensional barcodes of the FIGS. 171 and 172 included as representations in the captured image 201. The image generation unit 404 accesses the object information 300 designated as the link destination by the two-dimensional barcodes to obtain 3D model information for a time code included in the period between the time codes of the FIGS. 171 and 172. Further, the image generation unit 404 generates a virtual viewpoint image based on the obtained 3D model information and the virtual viewpoint determined by the condition determination unit 403, and then arranges each generated virtual viewpoint image at the position determined by the condition determination unit 403. Accordingly, virtual content is generated.

Herein, in a case where the number of pieces of 3D model information that may be obtained is greater than the number of virtual viewpoint images that may be arranged in the layout region 501, the image generation unit 404 selects and obtains some pieces of 3D model information such that the time codes of the obtained pieces of 3D model information are at approximately equal intervals, for example. Meanwhile, in a case where the number of pieces of 3D model information that may be obtained is less than the number of virtual viewpoint images that may be arranged in the layout region 501, the image generation unit 404 obtains all pieces of 3D model information that satisfy the conditions, for example. In such a case, the image generation unit 404 may re-determine the position at which each virtual viewpoint image is to be arranged in the layout region 501 based on the number of pieces of 3D model information that can be obtained. According to the thus generated virtual content, the shape or orientation of an object in the period between the time codes of the FIGS. 171 and 172 can be visualized such that comparison can be made.

FIG. 6B illustrates an example of a case where the width of the layout region 502 is smaller than the width of the region 571 or 572. In such a case, it is impossible to arrange virtual viewpoint images within the layout region 502. If virtual viewpoint images are arranged within the layout region 502, such images would overlap the representation 271 of the FIG. 171 or the representation 272 of the FIG. 172. Therefore, the image generation unit 404 does not arrange virtual viewpoint images in the layout region 502. Specifically, in such a case, the condition determination unit 403 determines the number of virtual viewpoint images to be arranged in the layout region 502 as zero, for example. In addition, the image generation unit 404 need not obtain 3D model information for generating virtual viewpoint images, or generate virtual content. However, in a case where no virtual viewpoint image is displayed as virtual content on the display apparatus 150, the user may feel uneasy. Therefore, the image generation unit 404 may generate, as virtual content, an image (hereinafter referred to as a “notification image”) for notifying that virtual viewpoint images are not displayed due to the narrow width of the layout region 502, in or near the layout region 502, for example.

FIG. 6C illustrates an example of a case where the width of the layout region 503 is greater than one but less than two times the width of the region 571 or 572. In such a case, the condition determination unit 403 determines the number of virtual viewpoint images to arranged in the layout region 503 as 1, and determines the arrangement position to be approximately the center of the layout region 503. For example, the image generation unit 404 obtains 3D model information for a time code corresponding to an approximate midpoint in the period between the time codes of the FIGS. 171 and 172 included as representations in the captured image 203, and generates a virtual viewpoint image corresponding to the 3D model information. Then, the image generation unit 404 arranges the generated virtual viewpoint image at approximately the center of the layout region 503.

The virtual viewpoint image generated by the image generation unit 404 in such a case is not limited to the foregoing virtual viewpoint image. For example, the image generation unit 404 may obtain 3D model information for a plurality of time codes included in the period from the time code of the FIG. 171 to the time code of the FIG. 172, and generate virtual viewpoint images corresponding to the respective pieces of 3D model information. In such a case, the image generation unit 404 alternately arranges the plurality of generated virtual viewpoint images in the layout region 503 in the chronological order of the time codes, for example. Such alternating arrangement of the virtual viewpoint images in the chronological order may allow the virtual viewpoint images to be displayed like a frame-by-frame moving image or a continuous animation in the virtual content, thereby visualizing changes in the shape or orientation of the object in the period. Note that such alternating arrangement of the virtual viewpoint images may also be performed in a case where the virtual viewpoint images are arranged at a plurality of positions in the layout region. In a case where the virtual viewpoint images are arranged at a plurality of positions in the layout region, it is desirable for the image generation unit 404 to arrange the virtual viewpoint images such that virtual viewpoint images corresponding to 3D model information for different time codes are displayed at the respective positions where the virtual viewpoint images are to be arranged.

FIG. 6D illustrates an example of a case where the size of the region 571 including the representation 271 of the FIG. 171 and the size of the region 572 including the representation 272 of the FIG. 172 differ from each other in the captured image 204. In the captured image 204, the region 572 including the representation 272 of the FIG. 172 is larger than the region 571 including the representation 271 of the FIG. 171. Such a difference in size may be due to the difference in size between the modeled figures, or due to the difference between the distance between the image capturing apparatus 130 and the FIG. 171 and the distance between the image capturing apparatus 130 and the FIG. 172. In a case where, as in the captured image 204, the sizes of the regions including the representations of the respective figures in the captured image differ from each other, it is desirable that virtual viewpoint images to be arranged in the layout region 504 be sized according to the sizes of the regions.

For example, in such a case, the image generation unit 404 determines the size of each virtual viewpoint image to be arranged so as to compensate for the difference in size between the region 571 including the representation 271 of the FIG. 171 and the region 572 including the representation 272 of the FIG. 172. Specifically, in the captured image 204, the width of the region 572 including the representation 272 of the FIG. 172 is larger than the width of the region 571 including the representation 271 of the FIG. 171. Assume that the number of virtual viewpoint images to be arranged in the layout region 504 is N, with the 0th virtual viewpoint image arranged in the region 571 and the (N+1)th virtual viewpoint image arranged in the region 572. Then, the widths of the respective virtual viewpoint images may be determined to obtain a geometric sequence with a predetermined common ratio. Herein, the common ratio R of the geometric sequence may be calculated with Equation (1) below, for example.

$$\begin{matrix}[ Math . 1 ] & \\ & Equation ( 1 )\end{matrix}$$

$$R = {( ( the width of the region 572 ) / ( the width of the region 571 ) )}^{1 / ( N + 1 )}$$

### Hardware Configuration of Image Processing Apparatus

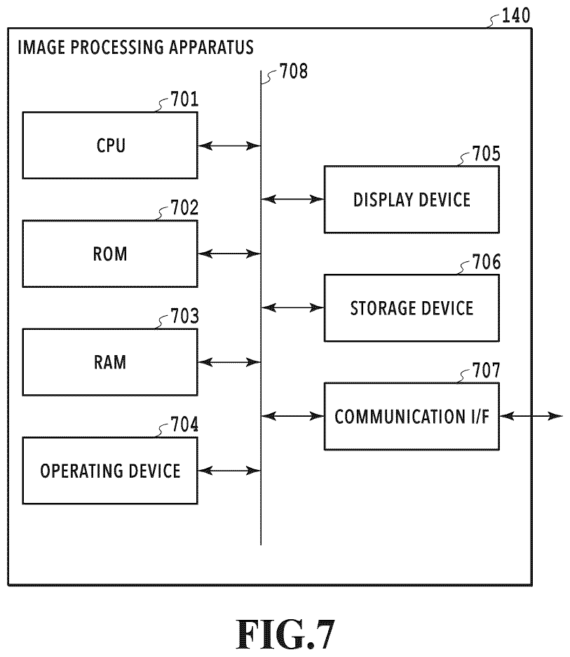

FIG. 7 is a block diagram illustrating an example of the hardware configuration of the image processing apparatus 140 according to Embodiment 1. The image processing apparatus 140 has, as its hardware configuration, a CPU 701, a RAM703, a ROM 702, an operating device 704, a display device 705, a storage device 706, and a communication I/F (interface) 707. The units included as the hardware configuration of the image processing apparatus 140 are connected to one another so as to communicate via a bus 708.

The CPU 701 controls the entire image processing apparatus 140 by using computer programs and various data stored in the RAM703, the ROM 702, or the storage device 706 to execute the computer programs. That is, each unit included as the logical configuration of the image processing apparatus 140 illustrated in FIG. 4 is implemented as the CPU 701 executes the corresponding computer program. The RAM703 is a volatile memory that temporarily stores computer programs and various data loaded from the ROM 702 or the storage device 706, as well as data obtained from the outside via the communication I/F 707, for example. The RAM703 serves as a work area used for the CPU 701 to execute various processes. In addition, the RAM703 is allocated as a frame memory, and stores various data, such as capturing information and camera parameters, for example. The RAM703 also manages the capturing information and the modeling information, for example. The ROM 702 is a non-volatile memory that stores setting data related to the image processing apparatus 140, and a boot program, for example.

The operating device 704 includes a keyboard or a mouse, for example. The operating device 704 receives operations from the user of the image processing apparatus 140, and inputs to the CPU 701 various instructions corresponding to the operations. The display device 705 includes a liquid crystal display, for example, and displays the results of processes performed by the CPU 701. The CPU 701 also operates as a control unit for the operating device 704 and the display device 705. Although the image processing apparatus 140 of this embodiment is described as having the operating device 704 and the display device 705, the image processing apparatus 140 need not have at least one of the operating device 704 and the display device 705. Specifically, for example, at least one of the operating device 704 and the display device 705 may be connected to the image processing apparatus 140 as its external device via the communication I/F 1707.

The storage device 706 is a high-capacity information storage device typified by a hard disk drive. The storage device 706 may store, for example, an OS (operating system) and a computer program for causing the CPU 701 to implement the function of each unit included as the logical configuration of the image processing apparatus 140 illustrated in FIG. 4. In addition, the storage device 706 may store various image data, capturing information, and modeling information, for example, to be processed. The computer programs and various data stored in the ROM 702 or the storage device 706 are loaded as appropriate into the RAM703 to be processed by the CPU 701 under the control of the CPU 701. The communication I/F 707 is an interface to which a network, such as a LAN (Local Area Network) or the Internet, and external apparatuses, such as the image capturing apparatus 130 and the display apparatus 150, are connected. The image processing apparatus 140 may obtain various information from the outside or may output the information to the outside, via the communication I/F 707.

### Operation of Image Processing Apparatus

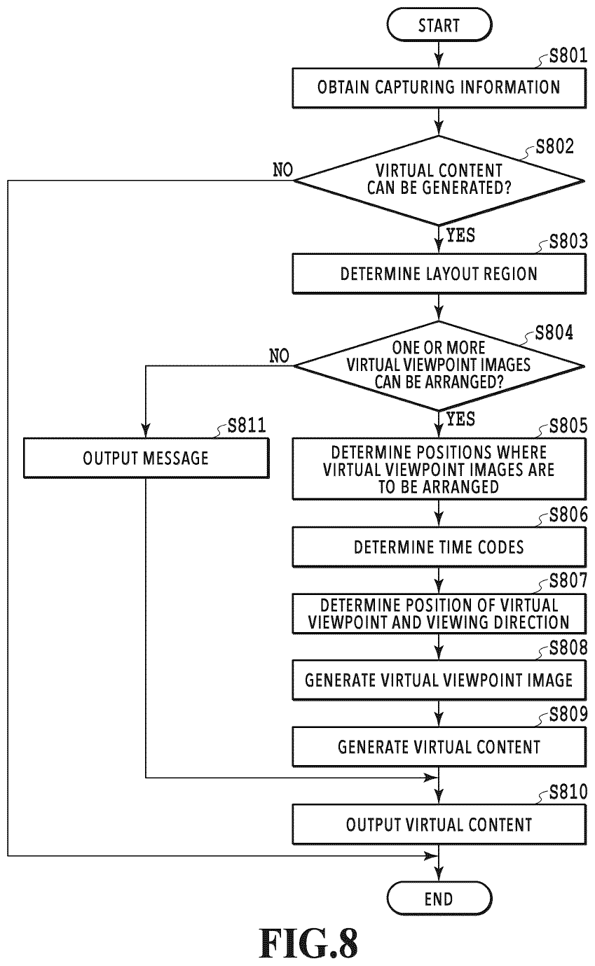

FIG. 8 is a flowchart illustrating an example of a process flow of the image processing apparatus 140 according to Embodiment 1. The processes of the flowchart illustrated in FIG. 8 are implemented as the CPU 701 loads the computer programs stored in the ROM 702 or the storage device 706, for example, into the RAM 703 and executes them. In the following description, symbol “S” prefixed to each reference sign means a process step.

First, in S801, the obtainment unit 400 obtains capturing information. A captured image contained in the capturing information includes representations of two-dimensional barcodes formed on the respective bases of the FIGS. 171 and 172 as illustrated in FIG. 2B, for example. The obtainment unit 400 obtains the modeling information 310 illustrated in FIG. 3B by decoding the two-dimensional barcode of the FIG. 171 included as a representation in the captured image. In addition, the obtainment unit 400 obtains the modeling information 330 illustrated in FIG. 3C by decoding the two-dimensional barcode of the FIG. 172 included as a representation in the captured image. The modeling information 310 and 330 obtained by decoding the two-dimensional barcodes with the obtainment unit 400 are transmitted to the generation judgment unit 402. In addition, the capturing information obtained by the obtainment unit 400, along with information indicating the base size, the attachment positions of the two-dimensional barcodes, and the sizes of the two-dimensional barcodes obtained by decoding the two-dimensional barcodes with the obtainment unit 400, is transmitted to the region determination unit 401.

Next, in S802, the generation judgment unit 402 judges if virtual content can be generated using the modeling information 310 and 330 obtained in S801. Specifically, the generation judgment unit 402 compares the item values 318 and 338 in the link destination field 312, and the item values 317 and 337 in the object ID field 311, contained in the modeling information 310 and 330. If such values are identical for each pair, and the item values 319 and 339 in the time code field 313 are different from each other, it follows that the captured image includes representations of a plurality of types of figures corresponding to an identical object. Therefore, in such a case, the generation judgment unit 402 judges that virtual content can be generated. Otherwise, the generation judgment unit 402 judges that virtual content cannot be generated. If it is judged that virtual content can be generated in S802, the image processing apparatus 140 executes the process in S803. Otherwise, the image processing apparatus 140 terminates the processes of the flowchart illustrated in FIG. 8.

In S803, the region determination unit 401 determines the layout region by estimating the arrangement and orientation of each of the image capturing apparatus 130 and the FIGS. 171 and 172. Specifically, the region determination unit 401 estimates the arrangement and orientation of each of the image capturing apparatus 130 and the FIGS. 171 and 172 using the camera parameters, information on the image sensor, and the captured image 201, each contained in the capturing information obtained in S801. For example, the region determination unit 401 associates the position and shape of the base of each figure as well as its two-dimensional barcode detected from the captured image 201 with the actual size of the figure, for example, using the camera parameters and the information on the image sensor. Accordingly, the arrangement and orientation of each of the image capturing apparatus 130 and the FIGS. 171 and 172 is estimated. Herein, the actual size of each figure, for example, may be identified using information on the shape of the base of the figure, and information on the size and attachment position of the two-dimensional barcode, each contained in the modeling information 310 or 330. For example, in a case where each figure is modeled on a rectangular prism-shaped base, the orientation of the figure may be estimated based on the orientation of the base and the attachment position of the two-dimensional barcode.

The way of estimating the orientation of each figure is not limited to the estimation based on the orientation of the base or the attachment position of the two-dimensional barcode. For example, the region determination unit 401 may estimate the orientation of each figure by identifying the features of the texture or shape of the figure in the captured image. In addition, in a case where a plurality of types of two-dimensional barcodes are formed on different surfaces of the base in advance by the modeling apparatus 120, for example, the region determination unit 401 identifies the correspondence between each two-dimensional barcode included as a representation in the captured image and the orientation of the figure. The orientation of each figure may also be estimated using such a method. Information on the layout region determined by the region determination unit 401 is transmitted to the condition determination unit 403. In addition, information on the region 571, which includes the representation 271 of the FIG. 171, and the region 572, which includes the representation 272 of the FIG. 172, in the captured image 201 obtained through image analysis by the region determination unit 401 is also transmitted to the condition determination unit 403.

In S804 after S803, the condition determination unit 403 judges if one or more virtual viewpoint images can be arranged in the layout region based on the information on the layout region determined in S803 and the information on the regions 571 and 572. Specifically, the condition determination unit 403 determines the number of virtual viewpoint images to be arranged in the layout region based on the sizes of the regions 571 and 572 and the size of the layout region determined in S803. If the determined number is one or more, it is judged that one or more virtual viewpoint images can be arranged in the layout region. If the determined number is zero, it is judged that one or more virtual viewpoint images cannot be arranged in the layout region. If it is judged that one or more virtual viewpoint images can be arranged in the layout region in S804, the image processing apparatus 140 executes processes of S805 to S809. Otherwise, the image processing apparatus 140 executes a process of S811.

In S811, the image generation unit 404 generates as virtual content a notification image for notifying that virtual viewpoint images are not displayed due to reasons such as the narrow width of the layout region 502. The notification image is not limited to the one for notifying that virtual viewpoint images are not displayed, and may include a message for prompting the user to change the arrangement of at least one of the FIGS. 171 and 172. After S 811, the image processing apparatus 140 executes a process of S 810.

In S805, the condition determination unit 403 determines the positions at which the virtual viewpoint images are to be arranged in the layout region. Specifically, the condition determination unit 403 determines the positions at which the virtual viewpoint images are to be arranged in the layout region, using the number of virtual viewpoint images to be arranged in the layout region determined in S804 and the information on the sizes of the layout region, the region 571, and the region 572 obtained in S803. Next, in S 806, the condition determination unit 403 determines the time codes for the 3D model information to be used to generate the virtual viewpoint images to be arranged, using the modeling information 310 and 330 obtained by decoding the two-dimensional barcodes in S801. Specifically, the condition determination unit 403 first identifies the period from, as the start point, the item value 319 in the time code field 313 contained in the modeling information 310 to, as the end point, the item value 339 in the time code field 313 contained in the modeling information 330. Next, the condition determination unit 403 equally divides the period using the number of virtual viewpoint images to be arranged in the layout region determined in S804, thereby calculating and determining as many time codes as the virtual viewpoint images.

Next, in S807, the condition determination unit 403 determines the position of a virtual viewpoint as well as the viewing direction to be used to generate each virtual viewpoint image, using the arrangement and orientation of each of the FIGS. 171 and 172 obtained in S803, the camera parameters, and the information on the image sensor. The position of a virtual viewpoint as well as the viewing direction to be used may be determined as a fixed value that does not change over time, or as a virtual camera path that changes over time. In a case where the position of a virtual viewpoint as well as the viewing direction to be used is determined as a fixed value, for example, the condition determination unit 403 determines it as follows. For example, the condition determination unit 403 determines the position of a virtual viewpoint as well as the viewing direction to be used such that the orientation of an object included as a representation in the virtual viewpoint image to be generated is perceived as being approximately the same as the orientation of the FIG. 171 or 172 included as a representation in the captured image. In a case where the orientation of the FIG. 171 significantly differs from that of the FIG. 172, the condition determination unit 403 may determine the position of a virtual viewpoint as well as the viewing direction to be used by calculating the mean value of the position of a virtual viewpoint as well as the viewing direction determined based on the orientation of each figure.

Meanwhile, in a case where the position of a virtual viewpoint as well as the viewing direction to be used is determined as a virtual camera path, the region determination unit 401 determines the virtual camera path as follows. For example, the region determination unit 401 determines the position of a virtual viewpoint as well as the viewing direction at the start point of the virtual camera path such that the orientation of an object included as a representation in the virtual viewpoint image to be generated is perceived as being approximately the same as the orientation of the FIG. 171 included as a representation in the captured image. In addition, the region determination unit 401 determines the position of a virtual viewpoint as well as the viewing direction at the end point of the virtual camera path such that the orientation of an object included as a representation in the virtual viewpoint image to be generated is perceived as being approximately the same as the orientation of the FIG. 172 included as a representation in the captured image. Note that in a case where the position of a virtual viewpoint as well as the viewing direction to be used are determined as a virtual camera path, virtual content may be generated as a moving image in a period corresponding to the virtual camera path. In addition, the region determination unit 401 may determine a virtual camera path where, in the period from the start point to the end point of the virtual camera path, the positions of the virtual viewpoint as well as the viewing directions are connected continuously, either linearly or in a predetermined curve shape.

In S808 after S807, the image generation unit 404 generates a virtual viewpoint image. Specifically, the image generation unit 404 first accesses the object information 300 to obtain 3D model information for the time code determined in S 806. Next, the image generation unit 404 generates a virtual viewpoint image by rendering the 3D model information based on the position of the virtual viewpoint as well as the viewing direction determined in S807. Next, in S809, the image generation unit 404 generates virtual content by arranging the virtual viewpoint image generated in S808 at the position determined in S805 in the layout region determined in S803. After S809, the image processing apparatus 140 executes the process of S810.

In S810, the output control unit 405 outputs the virtual content generated in S809 to the display apparatus 150. In addition, the output control unit 405 also outputs the captured image obtained in S801 to the display apparatus 150. The virtual content output in S810 is superimposed on the captured image, and the resulting image is displayed on the display apparatus 150. Note that if the process of S811 has been executed, the output control unit 405 outputs a notification image, which has been generated as virtual content in S811, to the display apparatus 150 in S810. In such a case, the notification image output in S810 is superimposed on the captured image, and the resulting image is displayed on the display apparatus 150. After S810, the image processing apparatus 140 terminates the processes of the flowchart illustrated in FIG. 8.

As described above, Embodiment 1 has described an aspect in which a state where a plurality of figures of an identical object, which correspond to different time codes, are arranged is captured. With the image processing apparatus 140 according to Embodiment 1, it is possible to, by adjusting the positions of the plurality of figures, display as virtual content a representation of the object corresponding to a time code of a figure that has not been captured. Accordingly, the user is able to simultaneously view the shapes or orientations of a target object at a plurality of time points in a period including a time code corresponding to a given figure, or in a period around the time code. In addition, the user is also able to adjust the position or orientation of each figure through intuitive operation. Accordingly, the user is able to easily view the display of a representation of the object corresponding to a time code of a figure that has not been captured, through intuitive operation.

### Embodiment 2

Embodiment 1 has described a configuration in which the aspect of the virtual content to be generated is changed by changing the number of virtual viewpoint images to be arranged, for example, based on the positional relationship of a plurality of figures. Embodiment 2 will describe virtual content generated in a case where a single figure is arranged and captured. Note that the system configuration of an image processing system according to Embodiment 2 is similar to that of the image processing system 100 according to Embodiment 1 illustrated in FIG. 1. Thus, the description thereof is omitted herein. In addition, the hardware configuration of the image processing apparatus according to Embodiment 2 is similar to that of the image processing apparatus 140 according to Embodiment 1. Thus, the description thereof is omitted herein. Further, the logical configuration of the image processing apparatus according to Embodiment 2 is also roughly similar to that of the image processing apparatus 140 according to Embodiment 1, but a process related to part of the logical configuration of the image processing apparatus according to Embodiment 2 differs from that of the image processing apparatus 140 according to Embodiment 1. Hereinafter, the image processing apparatus according to Embodiment 2 will be represented as an “image processing apparatus 140,” and the differences between processes performed by the image processing apparatus 140 according to Embodiment 2 and those performed by the image processing apparatus 140 according to Embodiment 1 will be described in detail.

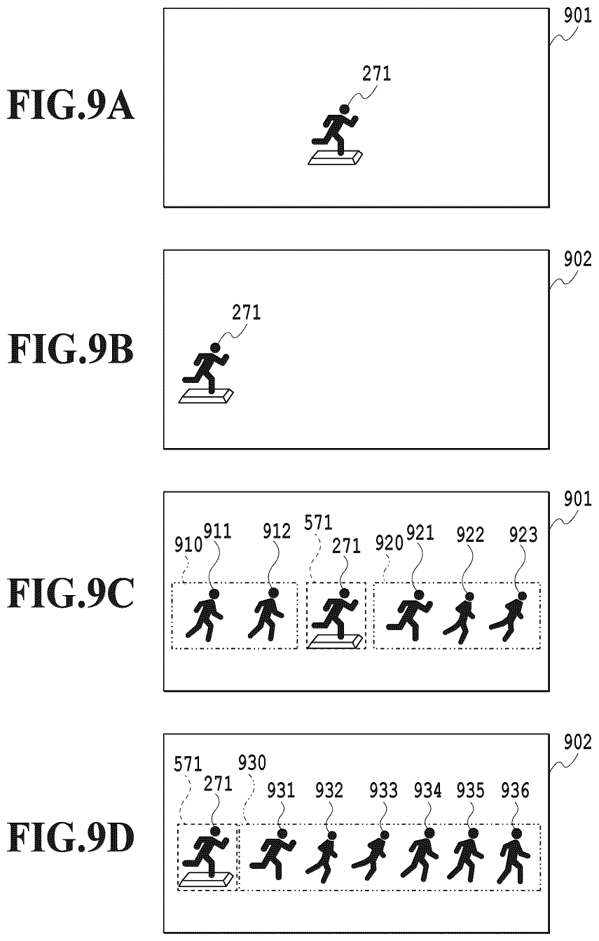

FIGS. 9A to 9D are views illustrating examples of a captured image contained in the capturing information obtained by the obtainment unit 400, and the arrangement of virtual viewpoint images in virtual content generated by the image generation unit 404, according to Embodiment 2. Specifically, FIGS. 9A and 9B respectively illustrate examples of captured images 901 and 902 obtained by the obtainment unit 400. Each of the captured images 901 and 902 includes the representation 271 of the FIG. 171. In addition, FIGS. 9C and 9D respectively illustrate an example of virtual content generated by the image generation unit 404 based on the captured image 901, and an example of virtual content generated by the image generation unit 404 based on the captured image 902. Note that FIGS. 9C and 9D each represent the state of an AR display where the virtual content generated by the image generation unit 404 and the captured image 901 or 902 contained in the capturing information obtained by the obtainment unit 400 are superimposed one on top of the other. As illustrated in FIG. 9C or 9D, virtual viewpoint images 911, 912, 921 to 923, and 931 to 936 are arranged in the layout region 910, 920, or 930.

The region determination unit 401 determines the region (i.e., layout region) where the virtual viewpoint images generated based on the 3D model information contained in the object information 300 are to be arranged in the virtual content. Specifically, the region determination unit 401 first estimates the arrangement and orientation of the FIG. 171, using the captured image 901 or 902 and camera parameters contained in the capturing information obtained by the obtainment unit 400, and each item value of the modeling information 310. The method for estimating the arrangement and orientation of the FIG. 171 is similar to the estimation method performed by the region determination unit 401 according to Embodiment 1. Thus, the description thereof is omitted herein. Next, the region determination unit 401 determines the layout regions 910 and 920 or the layout region 930 based on the estimated arrangement and orientation of the FIG. 171. Note that the region determination unit 401 may determine the layout regions 910 and 920 or the layout region 930 based on the position of the region 571 including the representation 271 of the FIG. 171 in the captured image 901 or 902. In such a case, the region determination unit 401 determines a region, which is adjacent to the region 571 including the representation 271 of the FIG. 171, in the captured image 901 or 902 as the layout regions 910 and 920 or the layout region 930, for example.

The condition determination unit 403 determines the conditions for generating virtual viewpoint images to be arranged in the layout regions 910 and 920 or the layout region 930. Specifically, the condition determination unit 403 determines the time code corresponding to the 3D model information to be used to generate each virtual viewpoint image, and the position of a virtual viewpoint as well as the viewing direction at the virtual viewpoint to be used to generate each virtual viewpoint image using the 3D model information. In addition, the condition determination unit 403 also determines the positions at which the generated virtual viewpoint images are to be arranged in the layout region. The method for determining the number of virtual viewpoint images and the position at which each virtual viewpoint image is to be arranged are similar to those of the condition determination unit 403 according to Embodiment 1. Thus, the description thereof is omitted herein.

For example, in the case of the layout regions 910 and 920, the condition determination unit 403 first selects and determines as many time codes as the virtual viewpoint images to be arranged in the layout region 910 from among the time codes preceding the item value 319 in the time code field 313 contained in the modeling information 310. Next, the condition determination unit 403 selects and determines as many time codes as the virtual viewpoint images to be arranged in the layout region 920 from among the time codes following the item value 319 in the time code field 313 contained in the modeling information 310. In the case of the layout region 930, the condition determination unit 403 selects and determines as many time codes as the virtual viewpoint images to be arranged in the layout region 930 from among the time codes following the item value 319 in the time code field 313 contained in the modeling information 310, for example. The interval between the selected time codes may be any interval set in advance or an interval designated by the user, for example. In addition, the condition determination unit 403 determines the position of a virtual viewpoint as well as the viewing direction to be used such that the orientation of an object included as a representation in the virtual viewpoint image to be generated is perceived as being approximately the same as the orientation of the FIG. 171 included as a representation in the captured image.

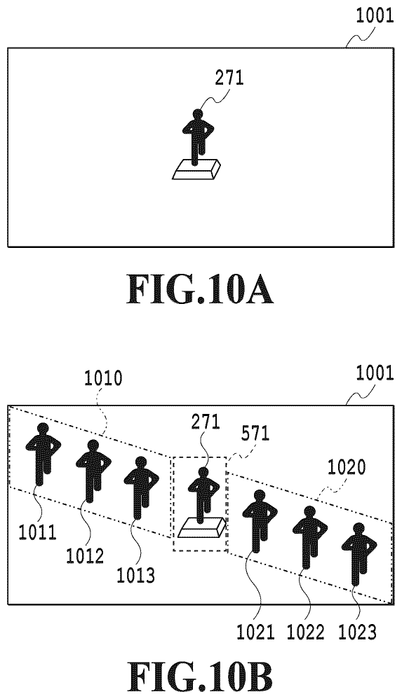

Although each of FIGS. 9C and 9D exemplarily illustrates a layout region where virtual viewpoint images are arranged side-by-side in the left-right direction of the drawing, the shape and arrangement of the layout region are not limited thereto. FIGS. 10A and 10B are views illustrating another example of a captured image contained in the capturing information obtained by the obtainment unit 400, and the arrangement of virtual viewpoint images in the virtual content generated by the image generation unit 404, according to Embodiment 2. Specifically, FIG. 10A illustrates a captured image 1001 obtained by the obtainment unit 400, and the captured image 1001 includes the representation 271 of the FIG. 171.

FIG. 10B illustrates an example of the virtual content generated by the image generation unit 404 based on the captured image 1001. Note that FIG. 10B represents the state of an AR display where the virtual content generated by the image generation unit 404 and the captured image 1001 contained in the capturing information obtained by the obtainment unit 400 are superimposed one on top of the other. As illustrated in FIG. 10B, virtual viewpoint images 1011 to 1013 and 1021 to 1023 are arranged in a layout region 1010 or 1020. The region determination unit 401 may determine as the layout region a region extending not in the left-right direction of the drawing, but in the up-down direction or the diagonal direction of the drawing, as exemplarily illustrated in FIG. 10B.

Although each of FIGS. 9C, 9D, and 10B exemplarily illustrates the layout region set such that the sizes of the virtual viewpoint images arranged therein are approximately the same, the layout region determined by the region determination unit 401 is not limited thereto. For example, the region determination unit 401 may determine as the layout region a trapezoidal region such as the layout region 504 illustrated in FIG. 6D.

According to the image processing apparatus 140 with the foregoing configuration, it is possible to, even in a state where a plurality of figures are not arranged, simultaneously view the shapes or orientations of an object corresponding to a figure at a plurality of time points. Therefore, a user who has obtained only one figure through purchase, for example, may be provided with an enhanced viewing experience.

### Other Embodiments

Although each of the foregoing embodiments has illustrated a configuration in which the generated virtual content is superimposed on the captured image for display, only the virtual content may be displayed. In such a case, for example, the image generation unit 404 may use 3D model information corresponding to a time code of a figure included as a representation in the captured image to generate a virtual viewpoint image corresponding to the time code, and arrange the generated virtual viewpoint image at the position of the representation of the figure.

In addition, each of the foregoing embodiments has illustrated a configuration in which the image generation unit 404 uses 3D model information corresponding to the time code determined by the condition determination unit 403 to generate a virtual viewpoint image corresponding to the time code, and arranges the generated virtual viewpoint image in the layout region. However, the image arranged in the layout region is not limited to such a virtual viewpoint image. For example, the image generation unit 404 may clip a region of a representation of an object corresponding to a figure out of the captured image corresponding to the time code determined by the condition determination unit 403, and arrange the clipped region in the layout region, instead of the virtual viewpoint image.

Further, each of the foregoing embodiments has illustrated a configuration in which the virtual content and the captured image are output to the display apparatus 150, and then, the display apparatus 150 displays an AR image by superimposing the virtual content on the captured image. However, the image processing apparatus 140 may generate an AR image by superimposing the virtual content on the captured image and output the AR image, and the display apparatus 150 may display the AR images output from the image processing apparatus 140.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

According to the technology of the present disclosure, it is possible to simultaneously view the orientations of a target object at a plurality of time points in a period including a time code corresponding to a figure, or in a period around the time code.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-229365, filed Dec. 25, 2024, which is hereby incorporated by reference herein in its entirety.

What is claimed is:

1. An image processing apparatus, comprising:
one or more hardware processors; and
one or more memories storing one or more programs configured to be executed by the one or more hardware processors, the one or more programs including instructions for:
obtaining capturing information containing data on a captured image and a camera parameter corresponding to the captured image, the captured image having been obtained by capturing a model figure corresponding to a shape of an object at a given time code, and
generating virtual content including a representation of the object corresponding to the model figure based on the capturing information.

2. The image processing apparatus according to claim 1, wherein the one or more programs further include instructions for:
determining a layout region based on the capturing information and generating the virtual content by arranging the representation of the object in the layout region.

3. The image processing apparatus according to claim 2, wherein the one or more programs further include instructions for:
determining the layout region based on a position of a region including a representation of the model figure in the captured image contained in the capturing information.

4. The image processing apparatus according to claim 3, wherein the one or more programs further include instructions for:
in a case where the captured image contained in the capturing information includes a representation of a first model figure corresponding to a shape of the object at a first time code and a representation of a second model figure corresponding to a shape of the object at a second time code different from the first time code, determining a region between a region including the representation of the first model figure and a region including the representation of the second model figure in the captured image as the layout region.

5. The image processing apparatus according to claim 1, wherein the one or more programs further include instructions for:
judging if generation of the virtual content is possible based on the capturing information, and
generating the virtual content in a case where generation of the virtual content is judged to be possible.

6. The image processing apparatus according to claim 5, wherein the one or more programs further include instructions for:
judging that generation of the virtual content is not possible in a case where the captured image contained in the capturing information includes representations of a plurality of model figures respectively corresponding to a plurality of different objects.

7. The image processing apparatus according to claim 1, wherein the one or more programs further include instructions for:
determining a time code of a representation of the object to be included in the virtual content based on a time code of the model figure.

8. The image processing apparatus according to claim 7, wherein the one or more programs further include instructions for:
in a case where the captured image contained in the capturing information includes a representation of a first model figure corresponding to a shape of the object at a first time code and a representation of a second model figure corresponding to a shape of the object at a second time code different from the first time code, determining a time code between the first time code and the second time code as the time code of the representation of the object to be included in the virtual content.

9. The image processing apparatus according to claim 1, wherein the one or more programs further include instructions for:
determining a layout region based on the capturing information, and
determining the number of representations of the object to be included in the virtual content based on a size of a region including a representation of the model figure in the captured image contained in the capturing information and a size of the layout region.

10. The image processing apparatus according to claim 9, wherein the one or more programs further include instructions for:
generating a notification image for providing a predetermined notification to a user in a case where the determined number of representations of the object satisfies a predetermined condition.

11. The image processing apparatus according to claim 9, wherein the one or more programs further include instructions for:
in a case where the determined number of representations of the object satisfies a predetermined condition, alternately arranging the representations of the object respectively corresponding to a plurality of time codes at an identical position in the virtual content.

12. The image processing apparatus according to claim 1, wherein the representation of the object included in the virtual content is a virtual viewpoint image corresponding to an appearance of the object seen from a virtual viewpoint, the virtual viewpoint image being generated based on three-dimensional shape data indicating the shape of the object.

13. The image processing apparatus according to claim 12, wherein
a position and a viewing direction of the virtual viewpoint are determined based on a position and an orientation of the model figure that have been estimated based on the captured image and the camera parameter contained in the capturing information.

14. The image processing apparatus according to claim 1, wherein the representation of the object included in the virtual content is an image obtained by clipping a region including the representation of the object out of a captured image obtained by capturing the object.

15. The image processing apparatus according to claim 1, wherein the one or more programs further include instructions for:
generating an image by superimposing the generated virtual content on the captured image contained in the capturing information.

16. An image processing method comprising the steps of:
obtaining capturing information containing data on a captured image and a camera parameter corresponding to the captured image, the captured image having been obtained by capturing a model figure corresponding to a shape of an object at a given time code, and
generating virtual content including a representation of the object corresponding to the model figure based on the capturing information.

17. A non-transitory computer readable storage medium storing a program for causing a computer to perform a control method of an image processing apparatus, the control method comprising the steps of:
obtaining capturing information containing data on a captured image and a camera parameter corresponding to the captured image, the captured image having been obtained by capturing a model figure corresponding to a shape of an object at a given time code, and
generating virtual content including a representation of the object corresponding to the model figure based on the capturing information.
